(19) United States
(12) Patent Application Publication
(10) Pub. No.: US 2002/0157085 A1
(43) Pub. Date: Oct. 24, 2002

(54) Information processing apparatus

(76) Inventors: Hiroyuki Yabuno, Osaka (JP); Takahiro Sato, Osaka (JP); Makoto Usui, Osaka (JP)

Correspondence Address: Ratner & Prestia, P.O. Box 980, Valley Forge, PA, 19482, US

(21) Appl. No.: 10/124,099

(22) Filed: Apr. 17, 2002

(30) Foreign Application Priority Data
Apr. 20, 2001 (JP) 2001-122435

(51) Int. Cl. G06F 9/44

(52) U.S. Cl. 717/126

(57) ABSTRACT

An information processing apparatus configured so as to be connectable to a debugging terminal includes: a CPU for executing a program; a monitor section for monitoring an execution status of the program; a debug communication section configured so as to be connectable to the debugging terminal; and an authentification section connected to the monitor section and the debug communication section, wherein the debug communication section receives debug information from the debugging terminal, the authentification section determines whether or not the monitor section is allowed to output monitor information corresponding to the debug information, according to whether the authentification section is in an authentificated state or in an unauthentificated state, and the debug communication section transmits to the debugging terminal the monitor information output from the monitor section.

### BACKGROUND OF THE INVENTION

1. Field of the Invention:

The present invention relates to an information processing apparatus including a debug communication section which can be connected to an external debugging terminal, wherein data stored in a memory incorporated in the information processing apparatus is protected from an unauthorized access while debugging is performed by the debugging terminal.

2. Description of the Related Art:

FIG. 11 shows a structure of a conventional target system 9010 which is subjected to debugging.

The target system 9010 includes a conventional information processing apparatus 901 and an external hardware 908.

The conventional information processing apparatus 901 includes: a memory 903 for storing a program; a CPU 902 for executing the program; an I/O device or other memory 907; a monitor section 905 for monitoring the execution status of the program in the memory 903, or the like; and a debug communication section 904. The debug communication section 904 can communicate with a debugging terminal 909.

The monitor section 905 receives debug information (debugging instruction data sequence) from the debug communication section 904, and accesses a designated memory or I/O device. Further, the monitor section 905 transmits to the debug communication section 904 an address or data stored in the memory or I/O device.

The debug communication section 904 transmits to/receives from the debugging terminal 909 a debugging instruction data sequence or an execution result data sequence. Debugging is performed on the target system 9010 including the information processing apparatus 901.

As shown in FIG. 11, the debugging terminal 909 is externally connected to the debug communication section 904 included in the information processing apparatus 901. In such an arrangement, debugging function such as breaking, step execution, accessing to the memory or I/O device, etc., become available. Thus, a program operation of the information processing apparatus 901 can be analyzed, and development of a program, debugging, malfunction analysis, etc., can be performed.

However, when debugging is performed using this debugging terminal 909,information stored in the memory 903 (e.g., incorporated ROM) of the information processing apparatus 901 can be readily read out through the monitor section 905 and the debug communication section 904 to an external device outside of the information processing apparatus 901. Further, an unspecified user can refer to or analyze a program in the information processing apparatus 901.

As described above, in a conventional information processing apparatus including a debug communication section for supporting debugging, a debugging terminal, which is provided outside of the information processing apparatus, is connected to the debug communication section. Thus, in such a structure, any user can externally retrieve information from the information processing apparatus. Therefore, it is difficult to protect information stored in a ROM, or the like, in the information processing apparatus, such as a program, from an unauthorized access.

### SUMMARY OF THE INVENTION

According to one aspect of the present invention, an information processing apparatus configured so as to be connectable to a debugging terminal includes: a CPU for executing a program; a monitor section for monitoring an execution status of the program; a debug communication section configured so as to be connectable to the debugging terminal; and an authentification section connected to the monitor section and the debug communication section, wherein the debug communication section receives debug information from the debugging terminal, the authentification section determines whether or not the monitor section is allowed to output monitor information corresponding to the debug information, according to whether the authentification section is in an authentificated state or in an unauthentificated state, and the debug communication section transmits to the debugging terminal the monitor information output from the monitor section.

In one embodiment of the present invention, the information processing apparatus further includes a memory in which the program is stored, wherein: when the authentification section is in the authentificated state, the authentification section permits the monitor section to output a value stored in the memory as the monitor information; and when the authentification section is in the unauthentificated state, the authentification section prohibits the monitor section from out putting the value stored in the memory and permits the monitor section to output an invalid value as the monitor information.

In another embodiment of the present invention, the debug information includes authentification data inherent to the debugging terminal; and the authentification section determines whether or not reference authentification data held in the authentification section matches with the authentification data, and when it is determined that the reference authentification data matches with the authentification data, the authentification section is set in the authentificated state.

In still another embodiment of the present invention, the debug information further includes a debugging instruction for debug processing of the program.

In still another embodiment of the present invention, the information processing apparatus further includes a memory in which the program is stored, wherein: the debug information includes authentification data inherent to the debugging terminal; and the authentification section determines which of a plurality of reference authentification data held in the authentification section matches with the authentification data, and the monitor section changes an accessible range of the memory according to a result of the determination.

In still another embodiment of the present invention, the authentification section is realized by a program, and the monitor section is realized by a program.

Thus, the invention described herein makes possible the advantages of (1) providing an information processing apparatus wherein information recorded in an incorporated memory, such as a program, is prevented from being disclosed to an unauthorized user who attempts to access the information; and (2) providing an information processing apparatus wherein, even if an unauthorized debugging terminal accesses the information processing apparatus of the present invention, a currently-executing process can be continued without making the unauthorized debugging terminal aware that the unauthorized terminal is subjected to an authentification process (i.e., without hang-up), and wherein debugging is not interrupted when a debugging terminal which does not require authentification accesses the information processing apparatus of the present invention.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of a target system according to embodiment 1 of the present invention, which is subjected to debugging.

FIG. 2 shows debug communication data sequences transmitted between an information processing apparatus of the present invention and a debugging terminal.

FIG. 3 shows an operation procedure of an information processing apparatus under the unauthentificated state for a memory read instruction.

FIG. 4 shows an example of an authentification procedure of a debugging operation.

FIG. 5 shows an operation procedure of an information processing apparatus under the authentificated state for a memory read instruction.

FIG. 6 shows a configuration of a target system according to embodiment 2 of the present invention, which is subjected to debugging.

FIG. 7 is a flowchart illustrating interruption processing.

FIG. 8 is a flowchart illustrating processing for a write instruction.

FIG. 9 is a flowchart illustrating processing for a read instruction.

FIG. 10 is a flowchart illustrating authentification processing.

FIG. 11 shows a configuration of a conventional target system which is subjected to debugging.

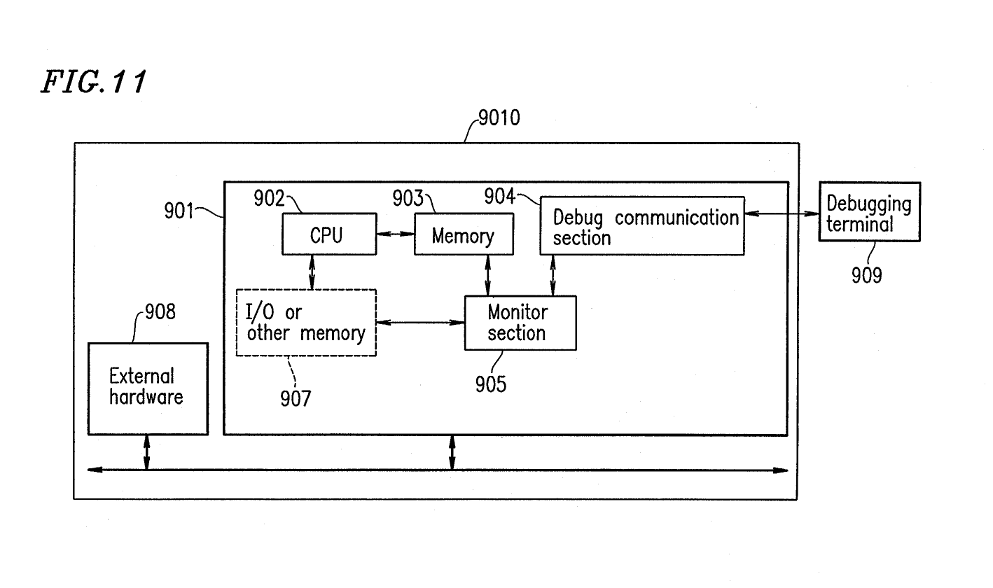

### DESCRIPTION OF THE PREFERRED EMBODIMENTS

Hereinafter, embodiments of the present invention will be described with reference to the drawings.

### EMBODIMENT 1

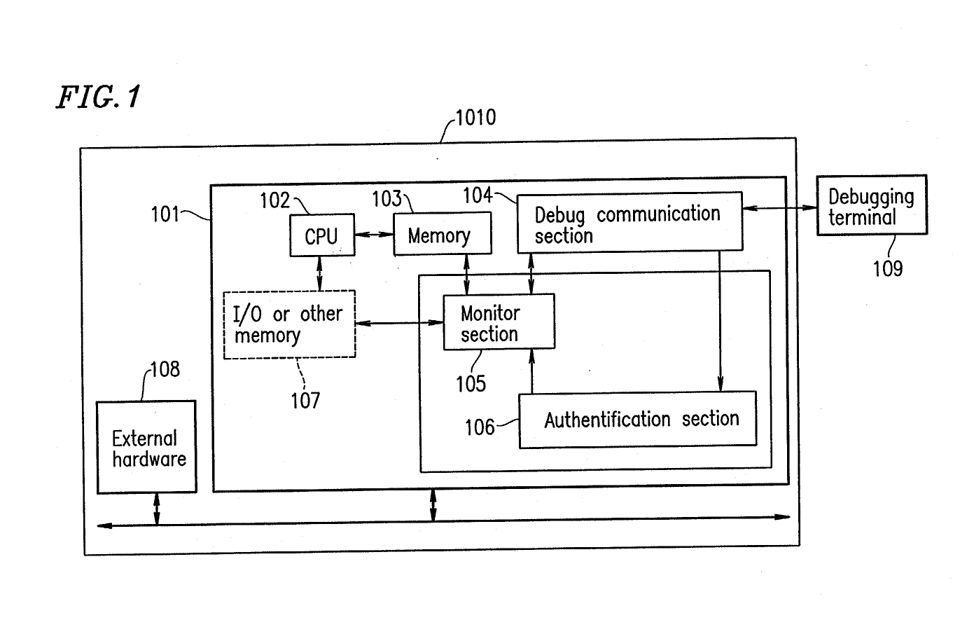

FIG. 1 shows a structure of a target system 1010 according to embodiment 1 of the present invention, which is subjected to debugging.

The target system 1010 includes an information processing apparatus 101 and external hardware 108. The information processing apparatus 101 and the external hardware 108 are connected to each other through a bus. The information processing apparatus 101 and the external hardware 108 can work together in a cooperative manner. The information processing apparatus 101 is configured so as to be connectable to a debugging terminal 109.

The information processing apparatus 101 includes: a CPU 102 for executing the program; a monitor section 105 for monitoring the execution status of the program; a debug communication section 104 which can communicate with a debugging terminal 109; and an authentification section 106 connected to the monitor section 105 and the debugging terminal 109.

The debug communication section 104 receives debug information from the debugging terminal 109. The authentification section 106 determines whether or not the monitor section 105 is allowed to output monitor information which corresponds to the debug information, according to whether the authentification section 106 is in the authentificated state or in the unauthentificated state. The debug communication section 104 transmits the monitor information output from the monitor section 105 to the debugging terminal 109.

The information processing apparatus 101 further includes a memory 103 for storing a program. The monitor section 105 can read data from, or write data in, the memory 103. The monitor section 105 can output the data read from the memory 103 as a monitor information which indicates the execution status of a program.

Further, the monitor section 105 may be configured so as to access an I/O device or other memory. In this case, the monitor section 105 may output a result of the access to the I/O device or other memory as monitor information.

Debugging of the target system 1010 including the information processing apparatus 101 is achieved by the debugging terminal 109, which issues various debugging instructions to change or acquire the state of the information processing apparatus 101. The minimum necessary functions of the debugging instructions include an accessing function which enables an access to various hardware resources connected to the incorporated CPU 102. The various hardware resources include a memory or an I/O register of other various hardware, for example, a memory for storing a program which drives the CPU 102.

The debugging instructions may be included in the debug information transmitted from the debugging terminal 109.

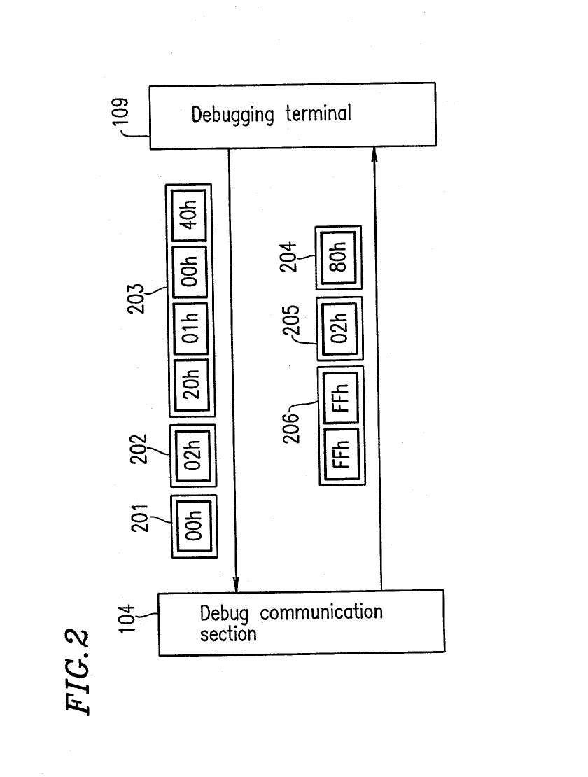

Next, a procedure for reading a content of the memory 103, in which a program is stored, during a debugging operation performed in the information processing apparatus 101 of embodiment 1 is described in detail with reference to FIGS. 2 through 5 in conjunction with FIG. 1.

FIG. 2 shows an example of debug communication data sequences transmitted between the debugging terminal 109 and the debug communication section 104 in the case of reading out the content of the memory 103 of the information processing apparatus 101 of embodiment 1.

In FIG. 2, reference numerals 201 and 204 denote ID data of the debug communication data sequences. Reference numerals 202 and 205 denote data which indicates an access width. Reference numeral 203 denotes a read-in address. Reference numeral 206 denotes read-in data. The data sequences 201, 202, and 203 shown in the upper part of FIG. 2 correspond to debug information which is transmitted from the debugging terminal 109 to the debug communication section 104. The data sequences 204, 205, and 206 shown in the lower part of FIG. 2 correspond to monitor information which is transmitted from the debug communication section 104 to the debugging terminal 109.

In response to receipt of the debug information (data sequences 201, 202, and 203) from the debugging terminal 109, the debug communication section 104 outputs the debug information to the authentification section 106. The authentification section 106 interprets the debug information as follows. The authentification section 106 interprets that the type of the debug information is “memory read” because ID data of the first data sequence 201 is “00h”, and that the byte width of the debug information is 2 bytes because the subsequent data sequence 202 is “02h”. Further, the authentification section 106 interprets that the address of the debug information is “40000120h” because the subsequent data sequence 203 is “20h, 01h, 00h, 40h”. That is, the authentification section 106 interprets that the received debug information is a memory read instruction for reading data of 2 bytes from a memory region starting from address 40000120h.

In the above description of embodiment 1, the ID data “00h” represents the memory read instruction, and the address is transmitted from the least significant bit (LSB) side. However, such a description, including the format of the debug communication data sequences, is merely an example of embodiment 1, and the present invention is not limited thereto. Further, it is assumed that the address is expressed in 32 bits, and the memory 103,in which the program is stored, starts with address 40000000h, but the present invention is not limited to such an assumption.

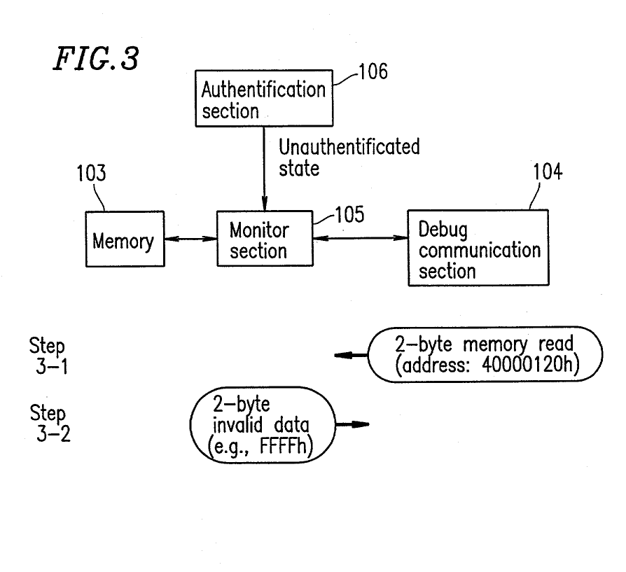

The debug communication section 104 receives the debug information (data sequences 201, 202, and 203) from the debugging terminal 109, and advises the monitor section 105 of contents of the debug information. The monitor section 105 accesses a region of the memory 103, or an I/O device or other memory, according to the debug information. The details of such an operation are described with reference to FIGS. 3 through 5. Assume that the authentification section 106 is in the authentificated state or the unauthentificated state. The state management of the authentification section 106 is achieved by an authentification flag included in the authentification section 106 which indicates the state of the authentification section 106 (authentificated state or unauthentificated state).

FIG. 3 shows an operation procedure of the information processing apparatus 101 followed in the case where the authentification section 106 is in the unauthentificated state, and a memory read instruction is executed in order to read data from the memory 103 in which a program is stored.

At step 3-1 of FIG. 3, the monitor section 105 receives from the debug communication section 104 a memory read instruction for reading data of 2 bytes from a memory region starting from address 40000120h. Then, at step 3-2, the monitor section 105 transmits to the debug communication section 104, in return, invalid data (invalid value) of 2 bytes, for example, FFFFh, rather than data actually read from the memory 103, because the authentification section 106 is in the unauthentificated state, i.e., reading of a value from the memory 103 is prohibited. The invalid data may be a fixed value, such as FFFFh, as described above. Alternatively, data prepared using random numbers so as to have a designated data length may be used as the invalid data. Such an invalid data is preferable because it is difficult for a third party to know that an authentification process is being executed.

As described above, in the unauthentificated state, reading of data from a designated memory by a third party can be disabled.

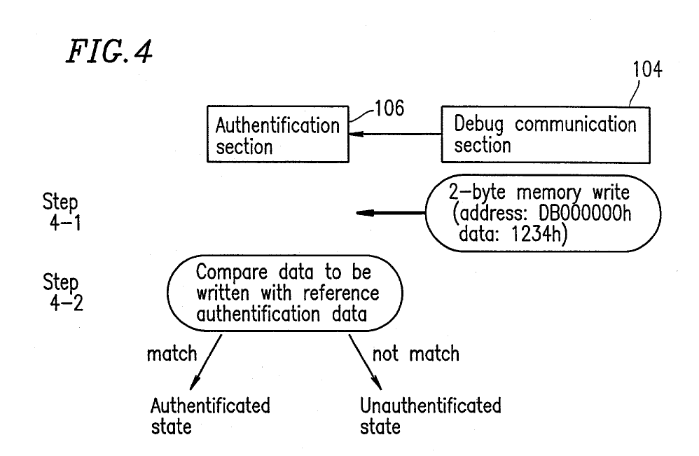

FIG. 4 shows an example of an authentification procedure of a debugging operation.

In an exemplary operation of the information processing apparatus 101 according to embodiment 1 described below, a memory write instruction for writing data of 2 bytes in a memory region starting from address DB000000h is executed, and data to be authentificated (hereinafter “authentification data”) is transmitted to the authentification section 106.

At step 4-1 of FIG. 4, the authentification section 106 receives from the debug communication section 104 a memory write instruction for writing data of 2 bytes in a memory region starting from memory address DB000000h. Since this memory write instruction is an instruction for writing data in address DB000000h or subsequent addresses, the authentification section 106 recognizes that the memory write instruction requires the authentification section 106 to change its state from the unauthentificated state to the authentificated state at step 4-2, and compares data to be written, 1234h, which is authentification data for this instruction, with reference authentification data previously held in the authentification section 106. If the authentification data to be written matches with the reference authentification data, the authentification section 106 is changed into the authentificated state; if not, the authentification section 106 is maintained in the unauthentificated state.

In the above described manner, the information processing apparatus 101 can determine whether or not the debugging terminal 109 is an authorized debugging terminal (whether or not a user using the debugging terminal 109 is a user who has permission to access the memory 103), and can manage the state of the authentification section 106 (authentificated state or unauthentificated state).

In the above exemplary operation of the information processing apparatus 101 according to embodiment 1, authentification data is transmitted to the authentification section by means of writing of 2-byte data in a memory region starting from address DB000000h. However, the address from which writing of data is begun is not limited to DB000000h. Further, the access width of the authentification data is not limited to 2 bytes, but may be 16 bytes or more, for example. In the case where the length of authentification data is long, a memory write instruction of the authentification data may be divided into a plurality of memory write instructions, and an instruction for starting authentification, which is issued after the plurality of memory write instructions, may be separately provided. Furthermore, in the above description of embodiment 1, it is assumed that, in the execution of the memory write instruction, a specific memory address is used for setting authentification data. However, an instruction format may be separately defined for authentification, in place of use of the memory write instruction. Further still, in the above description of embodiment 1, the authentification section 106 receives an instruction for authentification directly from the debug communication section 104. However, alternatively, the monitor section 105 may interrupt instructions for debugging en bloc, and if the interrupted instructions are instructions for authentification, the monitor section 105 may advise the authentification section 106 of the instructions for authentification.

It should be noted that, if the authentification section 106 is in the unauthentificated state, writing of data in a memory, an I/O device, or the like, is not performed even when a memory write instruction is issued.

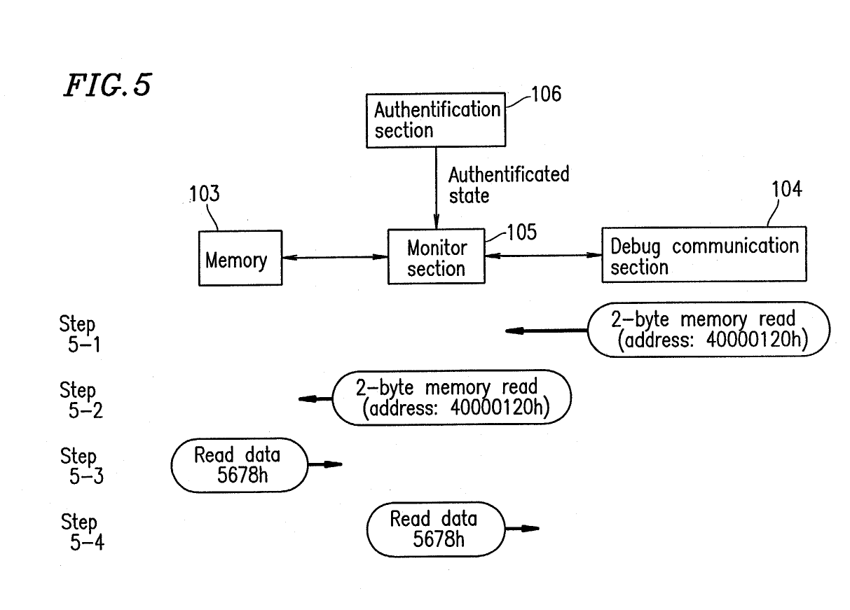

FIG. 5 shows an operation procedure of the information processing apparatus 101 followed in the case where the authentification section 106 is in the authentificated state, and a memory read instruction is executed in order to read data from the memory 103 in which a program is stored.

At step 5-1 of FIG. 5, the monitor section 105 receives from the debug communication section 104 a memory read instruction for reading data of 2 bytes from a memory region starting from address 40000120h. Then, at step 5-2, the monitor section 105 detects that the authentification section 106 is in the authentificated state, and performs a memory read operation to read a content of designated address 40000102h from the memory 103. Then, at step 5-3, the monitor section 105 obtains read data 5678h from the memory 103, and at step 5-4, the monitor section 105 advises the debug communication section 104 of the read data 5678h.

As described above with reference to FIGS. 3 through 5, in embodiment 1, the debug communication section 104, the monitor section 105, and the authentification section 106 operate in cooperation so as to access an interested section, such as a memory, according to a content of debug information (debug communication data sequence) received at the debug communication section 104. Data obtained by such an access is transmitted by the debug communication section 104, in return, to the debugging terminal 109 as monitor information (data sequences 204, 205, and 206), as shown in the lower part of FIG. 2. Thereafter, the debugging terminal 109 processes the read data obtained from the debug communication section 104, and if necessary, transmits another debugging instruction to the debug communication section 104 and displays debug information to a user. Further, even if the debugging terminal 109 receives an instruction about debugging from a user, the debugging terminal 109 communicates with the information processing apparatus 101 basically according to the above described manner, and changes the state of the information processing apparatus 101.

In the above description of embodiment 1, an access to a memory or I/O device is permitted/prohibited based on two states of the authentification section 106, i.e., the authentificated state and the unauthentificated state. However, according to the present invention, one or more authentificated states, in which only an access to a previously-designated part of a memory or I/O device is permitted, may be added, and different authentification data may be allocated to the respective authentificated states. With such an arrangement, the accessible range for debugging can be changed according to the type of a user. That is, it is determined with which of a plurality of reference authentification data held in the authentification section 106 authentification data matches, and the monitor section 105 can change the accessible range of the memory according to the determination result.

As described above, in the information processing apparatus 101 according to embodiment 1, information stored in an incorporated memory, such as a program, can be prevented from being disclosed to an unauthorized user who attempts to access the information. Further, even if the authentification section 106 is in the unauthentificated state, in response to a memory read instruction from a debugging terminal, invalid data having a designated data length is returned to the debugging terminal, rather than making no reply. Thus, even if an unauthorized debugging terminal, in which the authentification procedure of the present invention is not previously incorporated, accesses an information processing apparatus, a currently-executing process of the information processing apparatus can be continued without making the unauthorized debugging terminal aware that the unauthorized terminal is subjected to an authentification process (i.e., without hang-up). Furthermore, when a debugging terminal which does not require authentification accesses the information processing apparatus, a currently-executing process of the information processing apparatus can be continued without interrupting a debugging operation.

### EMBODIMENT 2

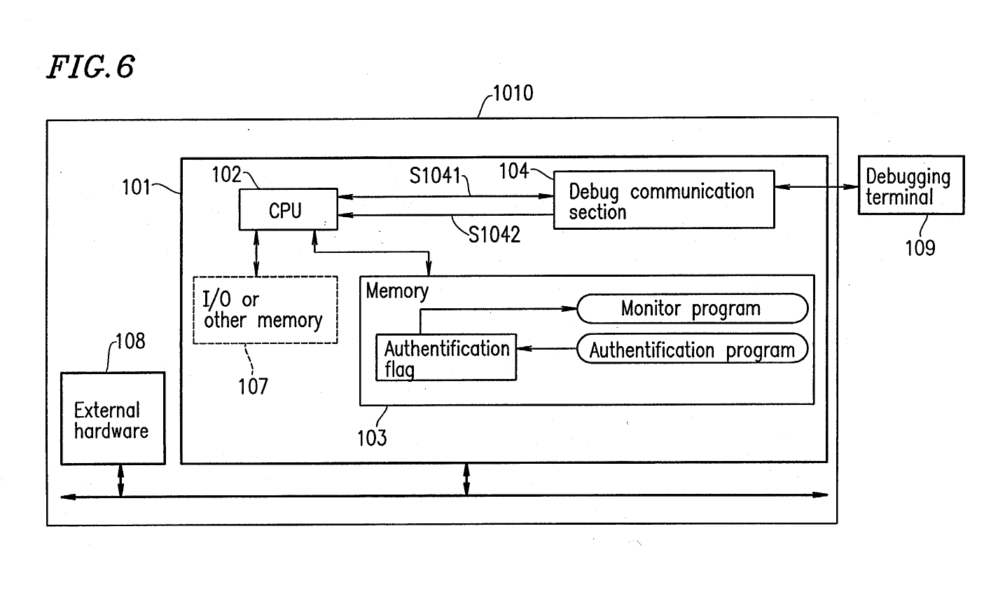

FIG. 6 shows a configuration of a target system 1010 according to embodiment 2 of the present invention, which is subjected to debugging.

In embodiment 2shown in FIG. 6, like elements are indicated by like reference numerals used in embodiment 1 shown in FIG. 1, and detailed descriptions thereof are omitted.

The target system 1010 includes an information processing apparatus 101 and an external hardware 108. The information processing apparatus 101 and the external hardware 108 are connected to each other through a bus. The information processing apparatus 101 and the external hardware 108 can work together in a cooperative manner. The information processing apparatus 101 is configured so as to be connectable to a debugging terminal 109.

The information processing apparatus 101 includes: a CPU 102 for executing the program; and a debug communication section 104 which can communicate with a debugging terminal 109. In embodiment 2, the monitor section (105) and the authentification section (106) shown in embodiment 1 are realized by a monitor program and an authentification program, respectively.

The information processing apparatus 101 further includes a memory 103. In embodiment 2, a user program of the CPU 102, a monitor program, and an authentification program can be stored in the memory 103. The information processing apparatus 101 may further include an I/O device or other memory 107. Reference numeral S1041 denotes a debug communication data sequence, and reference numeral S1042 denotes a debug communication interruption signal, which are described below.

Next, a procedure for reading a content of the memory 103, in which a program is stored, during a debugging operation performed in the information processing apparatus 101 of embodiment 2 is described in detail with reference to FIG. 2 and FIGS. 7 through 10 in conjunction with FIG. 6.

Detailed descriptions of FIG. 2 have already been described in embodiment 1, and therefore are herein omitted. In embodiment 2 also, an example of a debugging communication based on a memory read instruction is described, but the present invention is not limited thereto.

At the time when the debug communication data sequence (debug information) shown in the upper part of FIG. 2 reaches the debug communication section 104, the debug communication section 104 turns on the debug communication interruption signal S1042 shown in FIG. 6 and causes an interruption in the CPU 102, thereby notifying the CPU 102 that the debug communication data sequence has been input to the debug communication section 104.

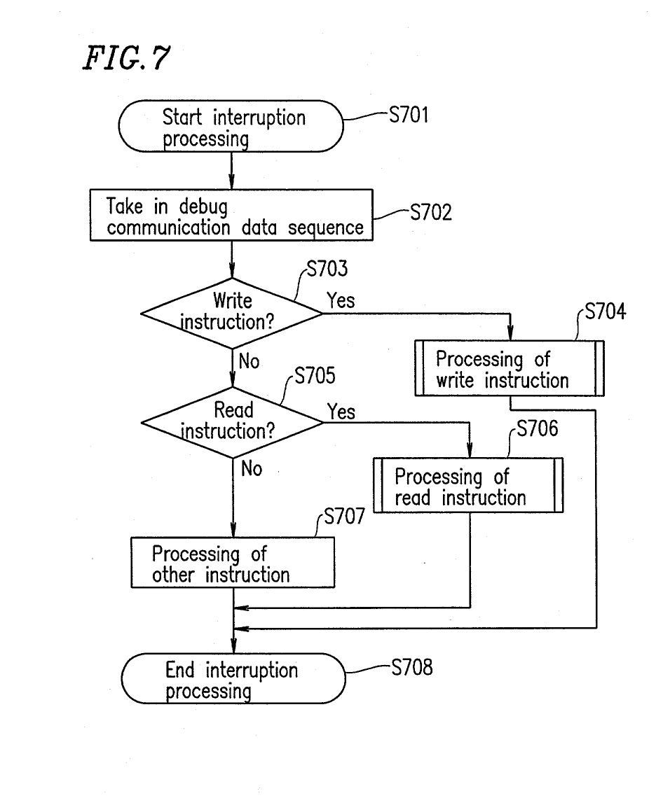

FIG. 7 is a flowchart illustrating interruption processing performed when a debug communication interruption is caused in the CPU 102.

The flowchart of FIG. 7 corresponds to a process performed by a monitor program stored in the memory 103.

First, at step S701, interruption processing is begun.

Next, at step S702, a debug communication data sequence is taken in from the debugging terminal 109, whereby ID data 201, access width data 202, and a read address 203, shown in the upper part of FIG. 2, are obtained.

Next, at step S703, a value of the ID data 201 of the obtained debug communication data sequence is checked so as to determine whether or not the debug communication data sequence is a write instruction. In the example shown in FIG. 2, the value of the ID data 201 is “00h”, which represents a memory read instruction. Thus, “No” is selected at step S703, and the process proceeds to step S705.

Next, at step S705, it is determined whether or not the debug communication data sequence is a read instruction. In this example, since the value of the ID data 201 is “00h” which represents a memory read instruction, “Yes” is selected, and the process proceeds to step S706.

Next, at step S706, processing of the read instruction, which will be described later, is performed. Thereafter, at step S708, the processing of the debug communication interruption is ended.

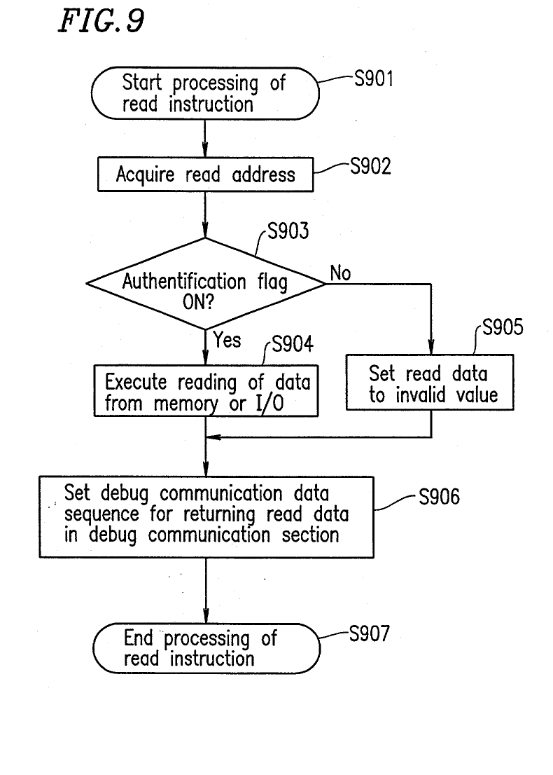

Next, the processing of the read instruction performed at step S706 of FIG. 7 is described in detail with reference to FIG. 9.

FIG. 9 is a flowchart illustrating a read processing.

The flowchart of FIG. 9 corresponds to a process performed by a monitor program stored in the memory 103.

First, at step S901, processing of the read instruction is begun.

Next, at step S902, a read-in address 203 of a debug communication data sequence (shown in the upper part of FIG. 2) is acquired.

Next, at step S903, it is determined whether or not an authentification flag is ON. If the authentification flag is OFF, i.e., in the initial state, “No” is selected at step S903, and the process proceeds to step S905.

Next, at step S905, read data (which will be returned to the debugging terminal 109 at step S906) is set to an invalid value. For example, every byte of the read data is set to “FFh”.

Next, at step S906, debug communication data, which is used for returning the invalid value set at step S905 to the debugging terminal 109, is set in the debug communication section 104. Through this processing, as shown in FIG. 2, the debug communication section 104 returns ID data 204, access width data 205, and read data 206 (shown in the lower part of FIG. 2) to the debugging terminal 109.

As described above, when the authentification flag is OFF, i.e., under the unauthentificated state, data is not read from a designated memory, and an invalid value is returned instead to a debugging terminal, whereby reading of data from the designated memory or I/O device can be disabled. The invalid value may be a fixed value as described in embodiment 1. However, it is more preferable to use, as the invalid data, data prepared using random numbers so as to have a designated data length.

If the authentification flag is ON, “Yes” is selected at step S903, and the process proceeds to step S904.

Next, at step S904, data is read from a memory or I/O device corresponding to the read address 203.

Next, at step S906, debug communication data sequence, which is used for returning data read out at step S904 to the debugging terminal 109, is set in the debug communication section 104. Through this processing, the debug communication section 104 returns the debug communication data sequence to the debugging terminal 109. When the authentification flag is ON (i.e., under the authentificated state), data actually read from a memory or I/O device is returned to the debugging terminal 109.

Referring again to FIG. 7, an exemplary operation of an authentification procedure in the debugging process is described below. In embodiment 2 also, an exemplary process flow of setting of authentification data, which is achieved by means of a memory write process where data of 2 bytes is written in a memory region starting from address DB000000h, is described.

At the time when the debug communication section 104 receives a memory write instruction for the above-described authentification process, a debug communication interruption is caused in the CPU 102, whereby the interruption processing shown in FIG. 7 is begun (step S701).

After the processing which is the same as the above-described memory read processing is performed, “Yes” is selected at step S703 of FIG. 7. Then, processing of the write instruction at step S704 is performed, and at step S708, the interruption processing is ended.

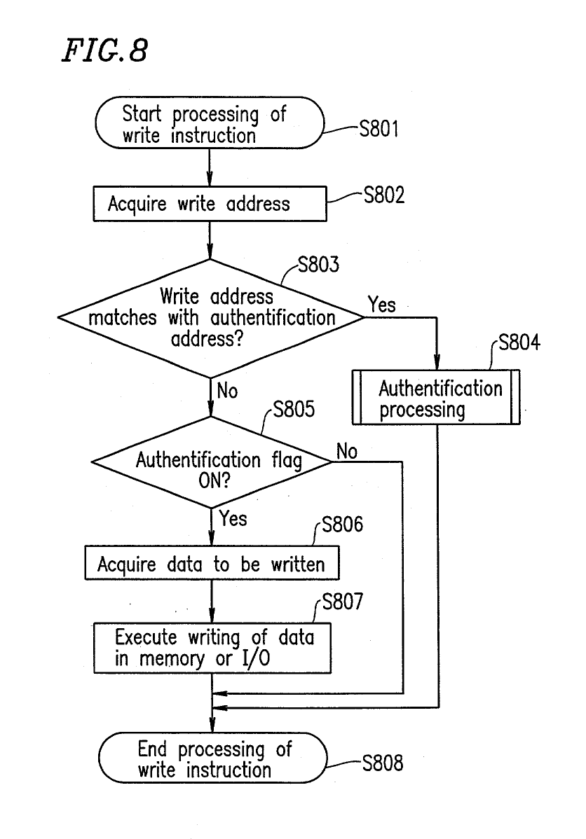

Next, the processing of the write instruction performed at step S704 of FIG. 7 is described in detail with reference to FIG. 8.

FIG. 8 is a flowchart illustrating a flow of write processing.

The flowchart of FIG. 8 also corresponds to a process performed by a monitor program stored in the memory 103.

First, at step S801, processing of the write instruction is begun.

Next, at step S802, a write address of a debug communication data sequence is acquired. In embodiment 2, the write address is DB000000h.

Next, at step S803, it is determined whether or not the write address acquired at step S802 matches with an address for authentification. Since the address for authentification is DB000000h in embodiment 2, “Yes” is selected at step S803, and the process proceeds to step S804.

Next, at step S804, authentification processing, which will be described later, is performed. Then, the process proceeds to step S808, at which the processing of the write instruction is ended.

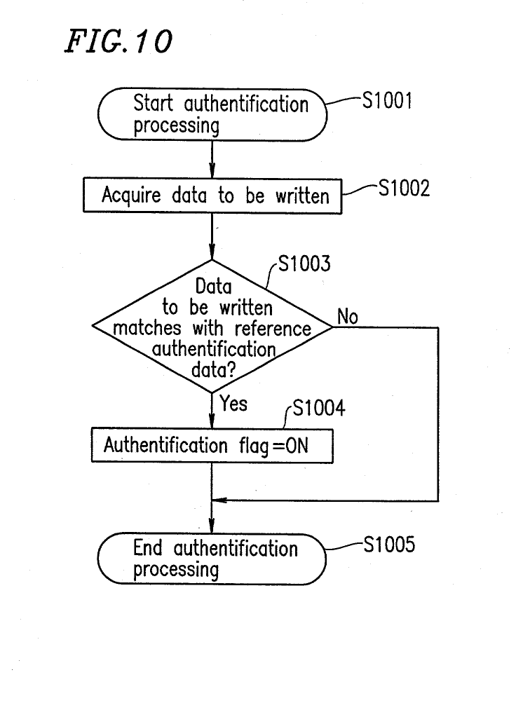

The authentification processing performed at step S804 of FIG. 8 is described in detail with reference to FIG. 10.

FIG. 10 is a flowchart illustrating a flow of authentification processing.

The flowchart of FIG. 10 corresponds to a process performed by an authentification program stored in the memory 103.

First, at step S1001, the authentification processing is begun.

Next, at step S1002, data to be written included in a debug communication data sequence is acquired. Also in this example of embodiment 2, the data to be written is “1234h”.

Next, at step S1003, the data to be written, 1234h, which was acquired at step S1002, is compared with reference authentification data previously incorporated in the authentification program. If data 1234h acquired at step S1002 matches with the reference authentification data (“Yes” at step S1003), the process proceeds to step S1004. If not (“No” at step S1003), the process skips step S1004 and proceeds to step S1005.

When “Yes” is selected at step S1003, the authentification flag is turned ON at step S1004, and the process proceeds to step S1005.

Lastly, at step S1005, the authentification processing is ended.

As described above, the authentification flag is turned ON only when authentification data set by the debugging terminal 109 matches with reference authentification data previously incorporated in the authentification program. Thus, the information processing apparatus 101 can authentificate whether or not a user of the debugging terminal 109 is an authorized user, and therefore can manage the authentification state of the user.

Also in the case where a memory write instruction is transmitted as a debug communication data sequence from the debugging terminal 109 to the debug communication section 104, a process for the memory write instruction is carried out according to the flowchart shown in FIG. 8, in a way similar to that for the memory read instruction, wherein data is actually written in a memory or I/O device only when the authentification flag is ON. The outline of this processing is the same as that of the memory read processing, and therefore, the detailed descriptions thereof are omitted. When the authentification flag is OFF, writing of data in a memory or I/O device is not performed even if a memory write instruction is transmitted from the debugging terminal 109 to the debug communication section 104,

As described above, according to embodiment 2, the CPU 102 and the debug communication section 104 operate in cooperation according to a monitor program and an authentification program stored in the memory 103. Based on debug information (debug communication data sequence) received at the debug communication section 104, the CPU 102 accesses an interested section, such as a memory. The CPU 102 outputs to the debug communication section 104 data obtained by such an access, and the debug communication section 104 returns the received data to the debugging terminal 109 as monitor information (data sequences 204, 205, and 206), as shown in the lower part of FIG. 2. Thereafter, the debugging terminal 109 processes the read data obtained from the debug communication section 104, and if necessary, transmits another debugging instruction to the debug communication section 104 and displays debug information to a user. Further, even if the debugging terminal 109 receives an instruction about debugging from a user, the debugging terminal 109 communicates with the information processing apparatus 101 basically according to the above described manner, and changes the state of the information processing apparatus 101.

In the above description of embodiment 2 also, an access to a memory or I/O device is permitted/prohibited based on an ON/OFF state of the authentification flag, i.e., two states of the authentification flag, i.e., the authentificated state and the unauthentificated state. However, according to the present invention, one or more authentificated states, in which only an access to a previously-designated part of a memory or I/O device is permitted, maybe added, and different authentification data may be allocated to the respective authentificated states. With such an arrangement, the accessible range for debugging can be changed according to the type of a user. That is, it is determined which of a plurality of reference authentification data held in an authentification section matches with authentification data, and a monitor section can change the range of the memory, from which data can be output, according to the determination result.

As described above, in the information processing apparatus according to embodiment 2, information recorded in an incorporated memory, such as a program, can be prevented from being disclosed to an unauthorized user who attempts to access the information. Further, even under the unauthentificated state, in response to a memory read instruction from a debugging terminal, invalid data having a designated data length is returned to the debugging terminal, rather than making no reply. Thus, even if an unauthorized debugging terminal, in which the authentification procedure of the present invention is not incorporated, accesses an information processing apparatus, a currently-executing process of the information processing apparatus can be continued without making the unauthorized debugging terminal aware that the unauthorized terminal is subjected to an authentification process (i.e., without hang-up). Furthermore, when a debugging terminal which does not require authentification accesses the information processing apparatus, a currently-executing process of the information processing apparatus can be continued without interrupting a debugging operation.

When employing an information processing apparatus of the present invention, information recorded in a memory incorporated in the information processing apparatus, such as a program, can be prevented from leaking to an unauthorized user who attempts to access the information.

Furthermore, according to an information processing apparatus of the present invention, even under the unauthentificated state, in response to a memory read instruction from a debugging terminal, invalid data having a designated data length is returned to the debugging terminal, rather than making no reply. Furthermore, when a debugging operation which does not require authentification is performed, a currently-executing debugging process can be continued. Thus, even if an unauthorized debugging terminal attempts to access the information processing apparatus, a debugging process can be executed without making a user who attempts to execute debugging processing aware that the authentification process is executed (i.e., without hang-up).

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An information processing apparatus configured so as to be connectable to a debugging terminal, comprising:
a CPU for executing a program;
a monitor section for monitoring an execution status of the program;
a debug communication section configured so as to be connectable to the debugging terminal; and
an authentification section connected to the monitor section and the debug communication section,
wherein the debug communication section receives debug information from the debugging terminal,
the authentification section determines whether or not the monitor section is allowed to output monitor information corresponding to the debug information, according to whether the authentification section is in an authentificated state or in an unauthentificated state, and
the debug communication section transmits to the debugging terminal the monitor information output from the monitor section.

2. An information processing apparatus according to claim 1, further comprising a memory in which the program is stored, wherein:
when the authentification section is in the authentificated state, the authentification section permits the monitor section to output a value stored in the memory as the monitor information; and
when the authentification section is in the unauthentificated state, the authentification section prohibits the monitor section from outputting the value stored in the memory and permits the monitor section to output an invalid value as the monitor information.

3. An information processing apparatus according to claim 1, wherein:
the debug information includes authentification data inherent to the debugging terminal; and
the authentification section determines whether or not reference authentification data held in the authentification section matches with the authentification data, and when it is determined that the reference authentification data matches with the authentification data, the authentification section is set in the authentificated state.

4. An information processing apparatus according to claim 3, wherein the debug information further includes a debugging instruction for debug processing of the program.

5. An information processing apparatus according to claim 1, further comprising a memory in which the program is stored, wherein:
the debug information includes authentification data inherent to the debugging terminal; and
the authentification section determines which of a plurality of reference authentification data held in the authentification section matches with the authentification data, and the monitor section changes an accessible range of the memory according to a result of the determination.

6. An information processing apparatus according to claim 1, wherein the authentification section is realized by a program, and the monitor section is realized by a program.
